(19) United States
(12) Patent Application Publication
(10) Pub. No.: US 2012/0006287 A1
(43) Pub. Date: Jan. 12, 2012

(54) ENGINE ASSEMBLY WITH INTEGRATED EXHAUST MANIFOLD

(75) Inventors: ALAN W. HAYMAN, ROMEO, MI (US); ERIC C. DOUSE, BLOOMFIELD HILLS, MI (US); ROBERT S. MCALPINE, LAKE ORION, MI (US)

(73) Assignee: GM GLOBAL TECHNOLOGY OPERATIONS, INC., DETROIT, MI (US)

(21) Appl. No.: 12/834,420

(22) Filed: Jul. 12, 2010

(51) Int. Cl. F02F 1/14; F02F 1/42

(52) U.S. Cl. 123/41.79; 123/193.5

(57) ABSTRACT

An engine assembly may include an engine structure, exhaust valves supported by the engine structure and a camshaft supported by the engine structure and engaged with the exhaust valves. The engine structure may define first, second, third and fourth combustion chambers arranged in series and a plurality of exhaust ports, each in communication with a corresponding combustion chamber. The engine structure may also define a flange region defining a first exhaust gas outlet axially aligned with the second combustion chamber and a second exhaust gas outlet axially aligned with the third combustion chamber. The engine structure may define first and second exhaust passages that extend from the first and second exhaust ports, respectively, to the first exhaust gas outlet and third and fourth exhaust passages that extend from the third and fourth exhaust ports, respectively, to the second exhaust gas outlet.

### FIELD

The present disclosure relates to engine assemblies, and more specifically to an engine assembly with an integrated exhaust manifold.

### BACKGROUND

This section provides background information related to the present disclosure which is not necessarily prior art.

An engine assembly may include an engine block that defines a plurality of cylinders. Each cylinder may be in communication with a fuel system, an intake manifold through at least one intake valve and an exhaust manifold through at least one exhaust valve. The size of the intake and exhaust valves, among other factors, affects engine operation. As the size of a cylinder bore becomes smaller, however, the size of each of the valves may also become correspondingly smaller. As valve size decreases, providing proper intake air and exhaust gas flow may become more difficult.

### SUMMARY

This section provides a general summary of the disclosure, and is not a comprehensive disclosure of its full scope or all of its features.

An engine assembly may include an engine structure, exhaust valves supported by the engine structure and a camshaft supported by the engine structure and engaged with the exhaust valves. The engine structure may define first, second, third and fourth combustion chambers arranged in series. The engine structure may further define a first exhaust port in communication with the first combustion chamber, a second exhaust port in communication with the second combustion chamber, a third exhaust port in communication with the third combustion chamber, and a fourth exhaust port in communication with the fourth combustion chamber. The engine structure may also define a flange region defining a first exhaust gas outlet axially aligned with the second combustion chamber and a second exhaust gas outlet axially aligned with the third combustion chamber, as well as a first exhaust passage extending from the first exhaust port to the first exhaust gas outlet, a second exhaust passage extending from the second exhaust port to the first exhaust gas outlet, a third exhaust passage extending from the third exhaust port to the second exhaust gas outlet, and a fourth exhaust passage extending from the fourth exhaust port to the second exhaust gas outlet.

A cylinder head may include first, second, third and fourth combustion chamber surfaces arranged in series, a flange portion and a body portion. The first combustion chamber surface may define a first exhaust port, the second combustion chamber surface may define a second exhaust port, the third combustion chamber surface may define a third exhaust port and the fourth combustion chamber surface may define a fourth exhaust port. The flange portion may define a first exhaust gas outlet axially aligned with the second combustion chamber surface and a second exhaust gas outlet axially aligned with the third combustion chamber surface. The body portion may define a first exhaust passage extending from the first exhaust port to the first exhaust gas outlet, a second exhaust passage extending from the second exhaust port to the first exhaust gas outlet, a third exhaust passage extending from the third exhaust port to the second exhaust gas outlet, and a fourth exhaust passage extending from the fourth exhaust port to the second exhaust gas outlet.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only and are not intended to limit the scope of the present disclosure in any way.

FIG. 1 is a schematic illustration of an engine assembly according to the present disclosure;

FIG. 2 is a schematic illustration of the engine assembly of FIG. 1 showing exhaust passages;

FIG. 3 is a schematic illustration of the combustion chambers and exhaust passages of the engine assembly of FIG. 1; and

FIG. 4 is a schematic illustration of the engine assembly of FIG. 1 showing exhaust passages and coolant passages.

Corresponding reference numerals indicate corresponding parts throughout the several views of the drawings.

### DETAILED DESCRIPTION

Examples of the present disclosure will now be described more fully with reference to the accompanying drawings. The following description is merely exemplary in nature and is not intended to limit the present disclosure, application, or uses.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

When an element or layer is referred to as being “on,” “engaged to,” “connected to” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

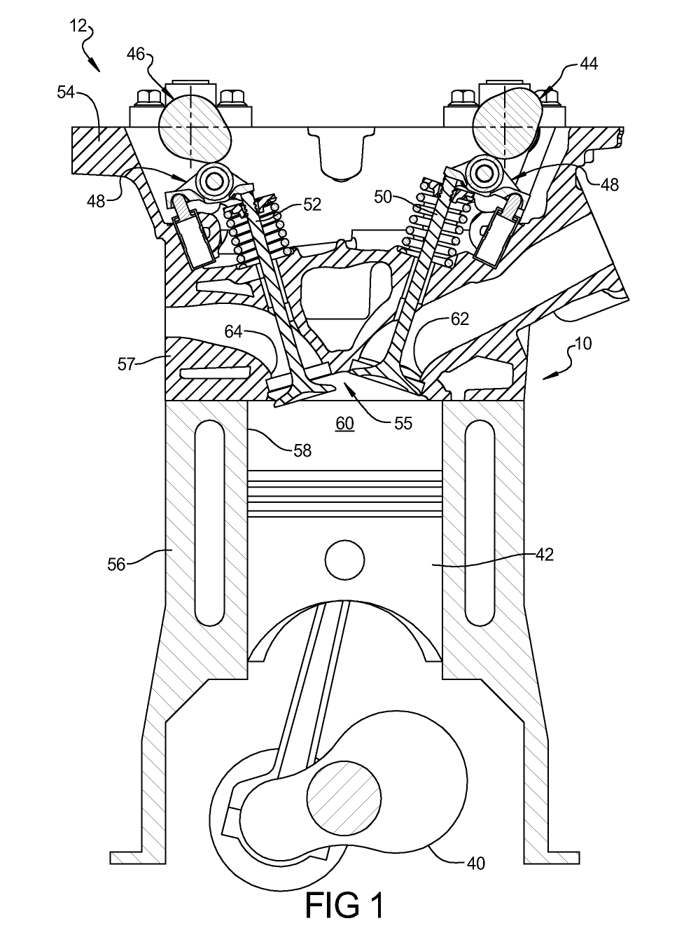

Referring to FIG. 1, an engine assembly 10 may include an engine structure 12, a crankshaft 40 rotationally supported by the engine structure 12, pistons 42 coupled to the crankshaft 40, intake and exhaust camshaft assemblies 44, 46 rotationally supported on the engine structure 12, valve lift assemblies 48, at least one intake valve 50 and at least one exhaust valve 52. In the present non-limiting example, the engine assembly 10 is shown as a dual overhead camshaft engine with the engine structure 12 including a cylinder head 54 rotationally supporting the intake and exhaust camshaft assemblies 44, 46 and an engine block 56 defining cylinder bores 58. It is understood, however, that the present disclosure is not limited to overhead camshaft configurations.

The pistons 42 may be disposed within the cylinder bores 58. The cylinder head 54 (for example, combustion chamber surfaces 55), the engine block 56 (for example, cylinder bores 58) and the pistons 42 may define a plurality of combustion chambers 60. The cylinder head 54 (for example, combustion chamber surfaces 55) may define at least one intake port 62 and at least one exhaust port 64 for each combustion chamber 60. The intake valve(s) 50 may open and close the intake port(s) 62 and the exhaust valve(s) 52 may open and close the exhaust port(s) 64. The valve lift assemblies 48 may be engaged with the intake camshaft assembly 44 and the intake valve(s) 50 to open the intake port(s) 62. Further, the valve lift assemblies 44 may be engaged with the exhaust camshaft assembly 46 and the exhaust valve(s) 52 to open the exhaust port(s) 64.

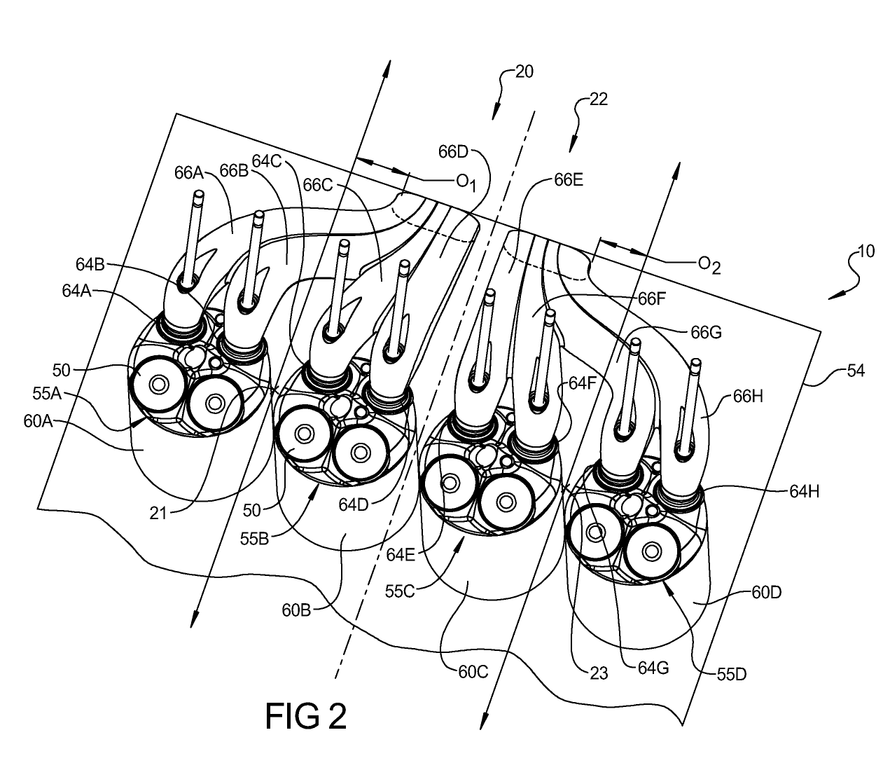

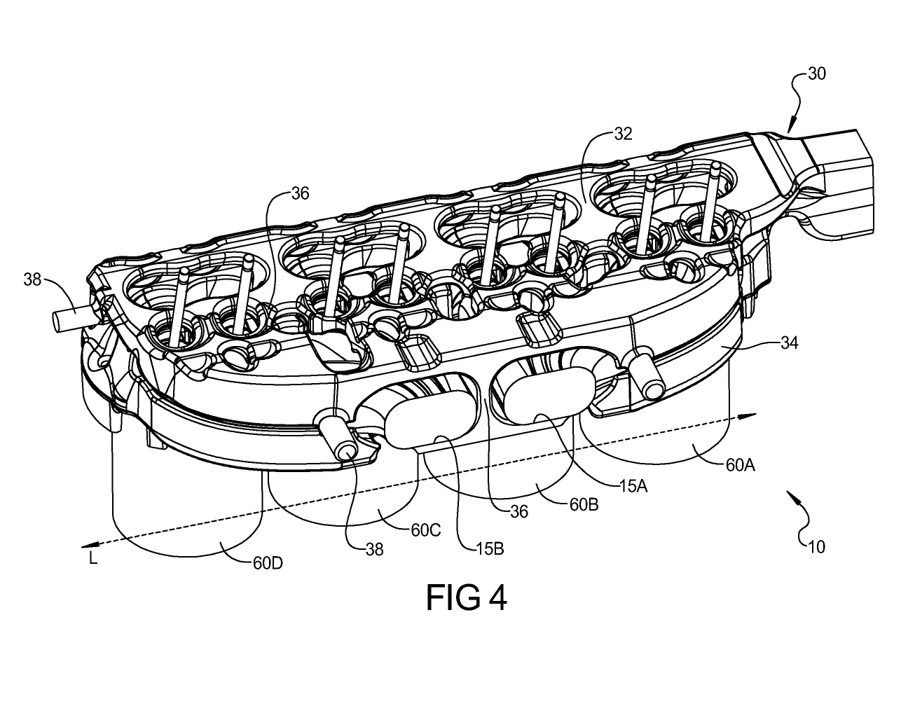

Referring to FIGS. 2-4, an exemplary engine assembly 10 according to the present disclosure is illustrated. Engine assembly 10 may include an engine structure 12 that defines a plurality of combustion chambers 60A-D to form a four-cylinder engine. The plurality of combustion chambers 60A-D may be grouped into a first group of combustion chambers 20 and a second group of combustion chambers 22. The first group of combustion chambers 20 may include a first combustion chamber 60A and a second combustion chamber 60B and the second group of combustion chambers 22 may include a third combustion chamber 60C and a fourth combustion chamber 60D. Each combustion chamber 60A-D may include at least one intake valve 50 and at least one exhaust valve 52. Intake valves 50 may be in communication with a structure for air intake, such as an intake manifold (not shown). Exhaust valves 52 may be in communication with an exhaust system (not shown), for example, through exhaust passages 66A-H.

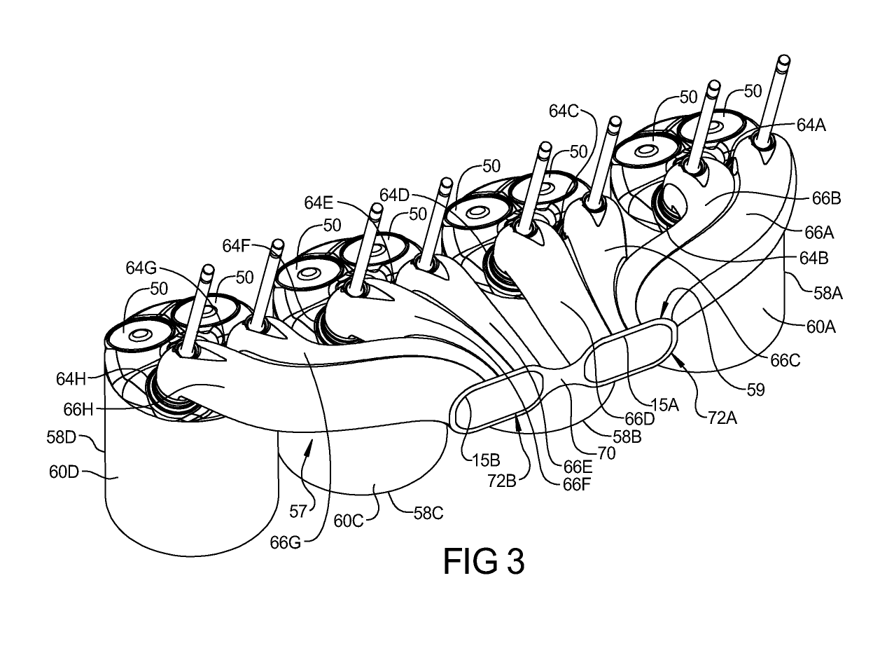

Each of the combustion chambers 60A-D may be connected to at least one of the exhaust passages 66A-H through an exhaust valve 52. For example, the first combustion chamber 60A may be in communication with a first exhaust passage 66A through a first exhaust port 64A and a second exhaust passage 66B through a second exhaust port 64B, the second combustion chamber 60B may be in communication with a third exhaust passage 66C through a third exhaust port 64C and a fourth exhaust passage 66D through a fourth exhaust port 64D, the third combustion chamber 60C may be in communication with a fifth exhaust passage 66E through a fifth exhaust port 64E and a sixth exhaust passage 66F through a sixth exhaust port 64F, and the combustion chamber 60D may be in communication with a seventh exhaust passage 66G through a seventh exhaust port 64G and an eighth exhaust passage 66H through an eighth exhaust port 64H. The exhaust passages 66A-H may be formed within a body portion 57 of the cylinder head 54. For simplicity of illustration, the exhaust passages 66A-H are illustrated in FIGS. 2-3 in the negative, that is, the exhaust passages 66A-H are shown as structures and the engine structure 12 (for example, cylinder head 54) that defines the exhaust passages 66A-H is absent (FIG. 3) or schematically represented for reference (FIG. 2).

In a non-limiting example, the first, second, third and fourth exhaust passages 66A-D may extend from the first, second, third and fourth exhaust ports 64A-D, respectively, to a first exhaust gas outlet 15A and the fifth, sixth, seventh and eighth exhaust passages 66E-H may extend from the fifth, sixth, seventh and eighth exhaust ports 64E-H to a second exhaust gas outlet 15B. The first and second exhaust gas outlets 15A-B may be defined by a flange region 59 of the engine structure 12 (for example, cylinder head 54). An exhaust flange gasket 70 may surround the first and second exhaust gas outlets 15A-B. In a non-limiting example, the exhaust flange gasket 70 may have a monolithic construction that defines a first gasket opening 72A and a second gasket opening 72B corresponding to the first exhaust gas outlet 15A and the second exhaust gas outlet 15B, respectively.

The first, second, third and fourth combustion chambers 60A-D may be arranged in series, for example, along a line L. Further, the cylinder head 54 may include first, second, third and fourth combustion chamber surfaces 55A-D arranged in series and the engine block may define first, second, third and fourth cylinder bores 58A-D arranged in series. In a non-limiting example, the first exhaust gas outlet 15A may be axially aligned with the second combustion chamber 60B (or second combustion chamber surface 55B). Similarly, the second exhaust gas outlet 15B may be axially aligned with the third combustion chamber 60C (or third combustion chamber surface 55C). In a further non-limiting example, an entirety of the first exhaust gas outlet 15A may be axially offset from the first combustion chamber 60A (or first combustion chamber surface 55A). Similarly, an entirety of the second exhaust gas outlet 15B may be axially offset from the fourth combustion chamber 60D (or fourth combustion chamber surface 55D).

In yet another non-limiting example, the first group of combustion chambers 20 may define a first midpoint 21 arranged midway between the first and second combustion chambers 60A-B (or first and second combustion chamber surfaces 55A-B). Similarly, the second group of combustion chambers 22 may define a second midpoint 23 arranged midway between the third and fourth combustion chambers 60C-D (or third and fourth combustion chamber surfaces 55C-D). The first exhaust gas outlet 15A may be axially offset from the first midpoint 21 by an offset O₁. Similarly, the second exhaust gas outlet 15B may be axially offset from the second midpoint 23 by an offset O₂.

Engine assembly 10 may further include an exhaust coolant jacket 30 at least partially surrounding the combustion chambers 60A-D and exhaust passages 66A-H. Exhaust coolant jacket 30 may define a first portion 32 of coolant passages 36 located on a first side of the engine structure 12 and a second portion 34 of coolant passages 36 located on a second side of the engine structure 12 opposite the first side. For simplicity of illustration, the coolant jacket 30 and coolant passages 36 are illustrated in FIG. 3 in the negative, that is, the coolant jacket 30 and coolant passages 36 are shown as structures and the engine structure 12 (for example, cylinder head 54) that defines the coolant jacket 30 and coolant passages 36 is absent or schematically represented.

Coolant may circulate through the exhaust coolant jacket 30 to cool the combustion chambers 60A-D, exhaust passages 66A-H and/or other portions of the engine assembly 10. Exhaust coolant jacket 30 may be connected to a supply of coolant (not shown) through one or more coolant ports 38. The first portion 32 and second portion 34 may be connected by one or more coolant passages 36 that allow coolant to pass from the first portion 32 to the second portion 34, from the second portion 34 to the first portion 32, or both. In a non-limiting example, a coolant passage 36 may be located between the first exhaust gas outlet 15A and the second exhaust gas outlet 15B. In this manner, each of the first and second exhaust gas outlets 15A-B may be cooled more efficiently, which may improve the durability of the exhaust flange gasket 70.

What is claimed is:

1. An engine assembly comprising:
an engine structure defining:
first, second, third and fourth combustion chambers arranged in series;
a first exhaust port in communication with the first combustion chamber, a second exhaust port in communication with the second combustion chamber, a third exhaust port in communication with the third combustion chamber, and a fourth exhaust port in communication with the fourth combustion chamber;
a flange region defining a first exhaust gas outlet axially aligned with the second combustion chamber and a second exhaust gas outlet axially aligned with the third combustion chamber;
a first exhaust passage extending from the first exhaust port to the first exhaust gas outlet, a second exhaust passage extending from the second exhaust port to the first exhaust gas outlet, a third exhaust passage extending from the third exhaust port to the second exhaust gas outlet, and a fourth exhaust passage extending from the fourth exhaust port to the second exhaust gas outlet;
exhaust valves supported by the engine structure and located in the first, second, third and fourth exhaust ports; and
a camshaft supported by the engine structure and engaged with the exhaust valves.

2. The engine assembly of claim 1, wherein the engine structure includes an engine block and a cylinder head fixed to the engine block, the engine block defining first, second, third and fourth cylinder bores arranged in series and the cylinder head defining the first, second, third and fourth exhaust ports and the first, second, third and fourth exhaust passages.

3. The engine assembly of claim 2, wherein the cylinder head defines a coolant jacket defining a coolant passage extending between the first and second exhaust gas outlets.

4. The engine assembly of claim 2, wherein the camshaft is supported by the cylinder head.

5. The engine assembly of claim 1, wherein the engine structure further defines:
a fifth exhaust port in communication with the first combustion chamber, a sixth exhaust port in communication with the second combustion chamber, a seventh exhaust port in communication with the third combustion chamber, and an eighth exhaust port in communication with the fourth combustion chamber; and
a fifth exhaust passage extending from the fifth exhaust port to the first exhaust gas outlet, a sixth exhaust passage extending from the sixth exhaust port to the first exhaust gas outlet, a seventh exhaust passage extending from the seventh exhaust port to the second exhaust gas outlet, and an eighth exhaust passage extending from the eighth exhaust port to the second exhaust gas outlet.

6. The engine assembly of claim 1, wherein an entirety of the first exhaust gas outlet is axially offset from the first combustion chamber.

7. The engine assembly of claim 6, wherein an entirety of the second exhaust gas outlet is axially offset from the fourth combustion chamber.

8. The engine assembly of claim 1, wherein the first exhaust gas outlet is axially offset from a first midpoint between the first and second combustion chambers.

9. The engine assembly of claim 8, wherein the second exhaust gas outlet is axially offset from a second midpoint between the third and fourth combustion chambers.

10. The engine assembly of claim 1, further comprising a monolithic exhaust flange gasket surrounding the first and second exhaust gas outlets.

11. A cylinder head comprising:
first, second, third and fourth combustion chamber surfaces arranged in series, the first combustion chamber surface defining a first exhaust port, the second combustion chamber surface defining a second exhaust port, the third combustion chamber surface defining a third exhaust port and the fourth combustion chamber surface defining a fourth exhaust port;
a flange portion defining a first exhaust gas outlet axially aligned with the second combustion chamber surface and a second exhaust gas outlet axially aligned with the third combustion chamber surface; and
a body portion defining a first exhaust passage extending from the first exhaust port to the first exhaust gas outlet, a second exhaust passage extending from the second exhaust port to the first exhaust gas outlet, a third exhaust passage extending from the third exhaust port to the second exhaust gas outlet, and a fourth exhaust passage extending from the fourth exhaust port to the second exhaust gas outlet.

12. The cylinder head of claim 11, wherein:
the first combustion chamber surface further defines a fifth exhaust port, the second combustion chamber surface further defines a sixth exhaust port, the third combustion chamber surface further defines a seventh exhaust port and the fourth combustion chamber surface further defines an eighth exhaust port; and
the body portion further defines a fifth exhaust passage extending from the fifth exhaust port to the first exhaust gas outlet, a sixth exhaust passage extending from the sixth exhaust port to the first exhaust gas outlet, a seventh exhaust passage extending from the seventh exhaust port to the second exhaust gas outlet, and an eighth exhaust passage extending from the eighth exhaust port to the second exhaust gas outlet.

13. The cylinder head of claim 12, wherein an entirety of the first exhaust gas outlet is axially offset from the first combustion chamber surface.

14. The cylinder head of claim 13, wherein an entirety of the second exhaust gas outlet is axially offset from the fourth combustion chamber surface.

15. The cylinder head of claim 11, wherein an entirety of the first exhaust gas outlet is axially offset from the first combustion chamber surface.

16. The cylinder head of claim 15, wherein an entirety of the second exhaust gas outlet is axially offset from the fourth combustion chamber surface.

17. The cylinder head of claim 16, wherein the body portion further defines a coolant jacket defining a coolant passage extending between the first and second exhaust gas outlets.

18. The cylinder head of claim 11, wherein the first exhaust gas outlet is axially offset from a first midpoint between the first and second combustion chamber surfaces.

19. The cylinder head of claim 18, wherein the second exhaust gas outlet is axially offset from a second midpoint between the third and fourth combustion chamber surfaces.

20. The cylinder head of claim 11, wherein the body portion further defines a cooling jacket including a cooling passage extending between the first and second exhaust gas outlets.
